(19) United States
(12) Patent Application Publication
(10) Pub. No.: US 2018/0316999 A1
(43) Pub. Date: Nov. 1, 2018

(54) HEADPHONE ATTACHMENT MECHANISM

(71) Applicant: Kimon Bellas, Camarillo, CA (US)

(72) Inventors: Kimon Bellas, Camarillo, CA (US); Alan Dwight Hulsebus, II, Simi Valley, CA (US)

(73) Assignee: Kimon Bellas, Camarillo, CA (US)

(21) Appl. No.: 15/498,330

(22) Filed: Apr. 26, 2017

(51) Int. Cl. H04R 1/10

(52) U.S. Cl. CPC H04R 1/1066; H04R 1/105; H04R 1/1008

(57) ABSTRACT

Devices and methods described herein relate to novel and improved headphone designs that can optimize component movement, efficiency, and/or performance. Headphone designs described herein allow components to freely move in many directions, which can provide users with an increased ability to optimize component positioning and/or performance. Additionally, headphone embodiments described herein can provide a novel manner to foster component adjustability, which also improves headphone efficiency and comfort. This component adjustability allows headphones to provide adjustable shapes and/or sizes, which helps to facilitate the transition to users of different sizes. Embodiments according to the present disclosure can also include headphones with removable components. For example, the headband can be removable from other headphone components. This can allow headphone components to be exchanged for similar components. In addition, removable individual components can provide headphone users with increased mobility and/or flexibility.

### BACKGROUND

### Field

The present disclosure relates generally to attachment devices and/or mechanisms, and more particularly to headphones with novel and improved attachment features and designs.

### Description of the Related Art

Headphones are a connected pair of speakers or listening devices that are designed to be worn on, over, or around a user's head or neck area and/or on or over the ears. Headphones typically emit sound though the use of transducers or speaker drivers, which are a type of audio transducer that converts electrical audio signals to sound waves. Speaker drivers are commonly associated with specialized transducers, which can reproduce a portion of the audible frequency range. A common type of speaker driver, often referred to as a dynamic or electrodynamic driver, converts electric current to sound waves via a coil of wire. This is widely known as a voice coil, which is often suspended between magnetic poles. During operation, a signal is delivered to the voice coil by means of electrical wires. The current flowing in the voice coil creates a magnetic field that causes a component, such as a diaphragm, to be forced in one direction or another. This force can move against a field established by magnetic gaps as the electrical signal varies. The back-and-forth, oscillatory motion drives the air in the device, which results in pressure differentials that convert to sound waves. Put more succinctly, speaker drivers utilize electrical audio signals to drive air through controlled movement, which in turn results in sound output.

Headphones use speaker drivers to produce sound into a user's ear, which are often in components distinct from the headband, such as cups or side speakers. Accordingly, headphones are designed to allow a user to listen to an audio source in a private manner. This type of use is in contrast with the use of speaker drivers by standard speakers, such as a loudspeaker, which emits sound publicly into the ambient. In order to emit sound into the user's ears, many types of headphones use a headband or band that can run around, on, or over the user's head to hold the speakers in the proper position. Additionally, to emit sound into a user's ears, headphones can connect to a source such as an audio signal, e.g. a CD or mp3 player, a portable media player, or a mobile phone. This connection can either be direct, such as by using a cord, or by using wireless technology, such as Bluetooth technology.

Because headphones use a headband or band that attaches to the side speakers, the ability to freely move in any direction can be restricted. Further, many headphones use designs that actually limit the movement of components. For example, some headphones use a hinge design that can restrict movement to individual rotation axes. Additionally, some headphones use designs that limit the way in which headphones can maneuver. For instance, some headphone designs use components that can limit the degree of spherical rotation.

In some instances, the aforementioned problems are attributable to the limited adjustability of the headphones. Headphones can often be bulky or restricted in the manner of movement. For example, most headphones keep the headband tightly adhered to the cup or side speakers. Accordingly, problems can be encountered when the user desires to move the headband separately from the cups or side speakers. Moreover, the ability to transport headphones can be restricted by this limited adjustability.

In an attempt to solve the problems mentioned above, those in the art have used a number of different structures. However, the aforementioned issues continue to exist, which continue to present problems for headphones.

### SUMMARY

The present disclosure relates to novel and improved headphone designs that optimize the movement and efficiency of components. Headphones according to the present disclosure can have an improved ability to facilitate component movement. The present disclosure also provides headphones that can freely separate individual components from one another. In addition, headphones described herein can provide a novel and improved manner in which to foster component adjustability, which can improve the efficiency and/or comfort for the user.

Embodiments according to the present disclosure can improve the overall component movement in headphones through a novel attachment mechanism or device. Headphone designs according to the present disclosure can increase the ability of components to freely move in a variety of directions, which can in turn provide more options to headphone users. Indeed, this increase in freedom of component movement provides headphone users with an increased ability to optimize component positioning and/or performance. As a result, the overall headphone user experience can be improved.

Headphones according to the present disclosure can also allow for an improved ability to adjust the component positioning. This in turn provides a variety of advantages, such as increased user comfort and satisfaction. Moreover, this component adjustability can allow headphones according to the present disclosure to have adjustable shapes and/or sizes. For instance, headphones according to the present disclosure can adjust one or more components in order to become more compact, which can prove useful to users for travel or mobility purposes. Likewise, headphone components can adjust to return back to their original positioning. Furthermore, component adjustability can help to facilitate the transition from one user to another, most notably users of different sizes.

Embodiments according to the present disclosure can also include headphones with removable components. For instance, the headband or band can be removable from the remaining headphone components, such as the cups or side speakers. This removable capability described herein includes a number of advantages, including the ability of headphone components to be exchanged for similar components of a different size. Additionally, the ability to remove individual components can prove useful to headphone users for travel or mobility purposes. It is understood that any component in the headphones according to the present disclosure can utilize the novel and improved features described in the embodiments herein.

One embodiment according to the present disclosure includes a headphone assembly comprising at least one speaker cup, an attachment cup, an attachment magnet, and a headband. In addition, the attachment cup can be on at least a portion of the speaker cup and the attachment magnet can be on at least a portion of the attachment cup. Furthermore, the headband can be on the attachment magnet.

Another embodiment according to the present disclosure includes a headphone assembly comprising at least one attachment assembly, which comprises a speaker cup, a sphere cup, an attachment device, and a headband. Additionally, the sphere cup can be on the speaker cup, the attachment device can be on the sphere cup, and the attachment device can be on the sphere cup. Moreover, the headband can be on the attachment device, wherein the headband substantially forms around the shape of the attachment device.

In yet another embodiment, the present disclosure can include a headphone assembly comprising a left cup assembly and a right cup assembly, wherein each cup assembly comprises a speaker cup, an attachment cup, and an attachment device. Further, the attachment cup can be on at least a portion of the speaker cup, and the attachment device can be on at least a portion of said attachment cup. The headphone assembly can also comprise a headband comprising a left attachment portion and a right attachment portion, wherein the left and right attachment portions are detachably on the left and right cup assemblies, respectively.

These and other further features and advantages of the disclosure would be apparent to those skilled in the art from the following detailed description, taken together with the accompanying drawings, in which:

### BRIEF DESCRIPTION OF THE DRAWINGS

FIG. 1A is a top side perspective view of one embodiment of a headphone assembly according to the present disclosure;

FIG. 1B is a side view of the headphone assembly in FIG. 1A;

FIG. 1C is a sectional cut-out view of the headphone assembly in FIG. 1A;

FIG. 2 is an exploded perspective view of one embodiment of a cup assembly according to the present disclosure;

FIG. 3 is a close-up view of one embodiment of an attachment assembly according to the present disclosure;

FIG. 4 is a top side perspective view of a sphere cup according to the present disclosure;

FIG. 5 is a top side perspective view of a sphere magnet according to the present disclosure;

FIG. 6 is a top side perspective view of a sphere insert according to the present disclosure;

FIG. 7 is a top side perspective view of one embodiment of a headband according to the present disclosure;

FIG. 8A is a top inside perspective view of one embodiment of a cup according to the present disclosure;

FIG. 8B is a top outside perspective view of one embodiment of a cup according to the present disclosure;

FIG. 9 is a top side perspective view of one embodiment of a tip cover according to the present disclosure;

FIG. 10 is a top side perspective view of one embodiment of a diaphragm according to the present disclosure;

FIG. 11 is a side view of one embodiment of a sound board according to the present disclosure;

FIG. 12 is a side view of one embodiment of a sound board cover according to the present disclosure;

FIG. 13 is a top side perspective view of one embodiment of an ear pad according to the present disclosure;

FIG. 14A is a top side perspective view of another embodiment of a headphone assembly according to the present disclosure;

FIG. 14B is a close-up view of an attachment assembly in the embodiment of FIG. 14A;

FIG. 14C is a top side perspective view of one embodiment of a tip bearing in the embodiment of FIG. 14A;

FIG. 14D is a top side perspective view of one embodiment of a tip magnet in the embodiment of FIG. 14A;

FIG. 14E is a top side perspective view of one embodiment of a tip pole in the embodiment of FIG. 14A;

FIG. 14F is a top side perspective view of a headband in the embodiment of FIG. 14A;

FIG. 15A is a top side perspective view of another embodiment of an attachment assembly according to the present disclosure;

FIG. 15B is a top side perspective view of a sphere cup in the embodiment of FIG. 15A;

FIG. 15C is a top side perspective view of a sphere magnet in the embodiment of FIG. 15A;

FIG. 15D is a top side perspective view of a headband in the embodiment of FIG. 15A;

FIG. 16A is a top side perspective view of a another embodiment of an attachment assembly according to the present disclosure;

FIG. 16B is a top side perspective view of a tip bearing in the embodiment of FIG. 16A;

FIG. 16C is a top side perspective view of a tip magnet in the embodiment of FIG. 16A;

FIG. 16D is a top side perspective view of a tip pole in the embodiment of FIG. 16A;

FIG. 16E is a top side perspective view of a headband in the embodiment of FIG. 16A;

FIG. 17A is a top side perspective view of another embodiment of an attachment assembly according to the present disclosure;

FIG. 17B is a top side perspective view of a tip bearing in the embodiment of FIG. 17A;

FIG. 17C is a top side perspective view of a tip magnet in the embodiment of FIG. 17A;

FIG. 17D is a top side perspective view of a tip pole in the embodiment of FIG. 17A;

FIG. 17E is a top side perspective view of a headband in the embodiment of FIG. 17A;

FIG. 18A is a top side perspective view of another embodiment of an attachment assembly according to the present disclosure;

FIG. 18B is a top side perspective view of a tip bearing in the embodiment of FIG. 18A;

FIG. 18C is a top side perspective view of a tip magnet in the embodiment of FIG. 18A;

FIG. 18D is a top side perspective view of a tip pole in the embodiment of FIG. 18A; and

FIG. 18E is a top side perspective view of a headband in the embodiment of FIG. 18A.

### DETAILED DESCRIPTION

The present disclosure relates to novel and improved headphone designs that can optimize and improve component movement, efficiency, and/or performance. Embodiments herein can facilitate the movement of components through a novel attachment mechanism or device. Headphone designs described herein can allow components to freely move in many directions, which can provide users with an increased ability to optimize component positioning and/or performance and allows for an improved user experience. Additionally, headphone embodiments described herein can provide a novel manner in which to foster component adjustability, which can also improve the headphone efficiency and comfort. This component adjustability can allow headphones herein to provide adjustable shapes and/or sizes, which can help to facilitate the transition to users of different sizes. Embodiments according to the present disclosure can also include headphones with removable and/or separable components. For example, the headband or band can be removable from other headphone components, such as the cups or side speakers. This can allow headphone components to be exchanged for similar components. In addition, removable individual components can provide headphone users with increased mobility and/or flexibility.

Attachment assemblies, devices, and/or mechanisms according to the present disclosure are described herein as being utilized with headphones and/or speakers. However, it is understood that attachment assemblies according to the present disclosure can be used in a wide variety of audio devices, including but not limited to headphones or speakers, as well as any device that utilizes or can benefit from utilizing a novel and improved attachment mechanism. It is also understood that any component in the attachment assemblies according to the present disclosure can utilize the novel and improved features described in the embodiments herein. Moreover, any individual component or combination of components described herein can be used in any appropriate device or attachment application.

Throughout this disclosure, the preferred embodiment and examples illustrated should be considered as exemplars, rather than as limitations on the present disclosure. As used herein, the term “invention,” “device,” “apparatus,” “method,” “disclosure,” “present invention,” “present device,” “present apparatus,” “present method” or “present disclosure” refers to any one of the embodiments of the disclosure described herein, and any equivalents. Furthermore, reference to various feature(s) of the “invention,” “device,” “apparatus,” “method,” “disclosure,” “present invention,” “present device,” “present apparatus,” “present method” or “present disclosure” throughout this document does not mean that all claimed embodiments or methods must include the referenced feature(s).

It is also understood that when an element or feature is referred to as being “on” or “adjacent” to another element or feature, it can be directly on or adjacent the other element or feature or intervening elements or features may also be present. In contrast, when an element is referred to as being “directly on” or extending “directly onto” another element, there are no intervening elements present. Additionally, it is understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present.

Furthermore, relative terms such as “inner,” “outer,” “upper,” “top,” “above,” “lower,” “bottom,” “beneath,” “below,” and similar terms, may be used herein to describe a relationship of one element to another. Terms such as “higher,” “lower,” “wider,” “narrower,” and similar terms, may be used herein to describe angular relationships. It is understood that these terms are intended to encompass different orientations of the elements or system in addition to the orientation depicted in the figures.

Although the terms first, second, third, etc., may be used herein to describe various elements, components, regions, and/or sections, these elements, components, regions, and/or sections should not be limited by these terms. These terms are only used to distinguish one element, component, region, or section from another. Thus, unless expressly stated otherwise, a first element, component, region, or section discussed below could be termed a second element, component, region, or section without departing from the teachings of the present disclosure. As used herein, the term “and/or” includes any and all combinations of one or more of the associated list items.

The terminology used herein is for the purpose of describing particular embodiments only and is not intended to be limiting of the disclosure. As used herein, the singular forms “a,” “an,” and “the” are intended to include the plural forms as well, unless the context clearly indicates otherwise. For example, when the present specification refers to “an” assembly, it is understood that this language encompasses a single assembly or a plurality or array of assemblies. It is further understood that the terms “comprises,” “comprising,” “includes,” and/or “including” when used herein, specify the presence of stated features, integers, steps, operations, elements, and/or components, but do not preclude the presence or addition of one or more other features, integers, steps, operations, elements, components, and/or groups thereof.

Embodiments of the disclosure can be described herein with reference to view illustrations that are schematic illustrations. As such, the actual thickness of elements can be different, and variations from the shapes of the illustrations as a result, for example, of manufacturing techniques and/or tolerances are expected. Thus, the elements illustrated in the figures are schematic in nature and their shapes are not intended to illustrate the precise shape of a region and are not intended to limit the scope of the disclosure.

It is understood that while the present disclosure makes reference to attachment assemblies with novel and efficient designs, and that headphone assemblies may be the primary application concerned with the present disclosure, devices incorporating features of the present disclosure can be utilized with any application that has components or elements which might be concerned with attachment devices, mechanisms and/or applications, or any similar application that may benefit from a novel and efficient component design.

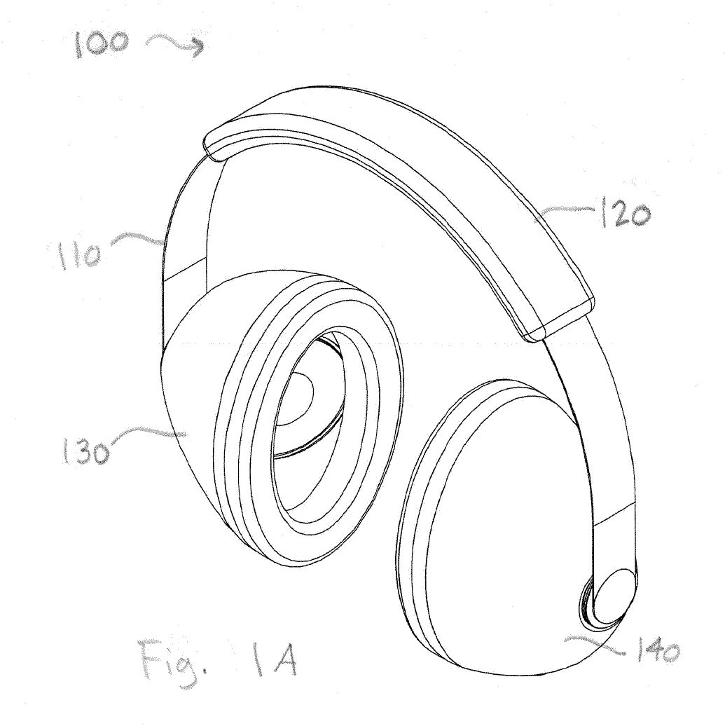

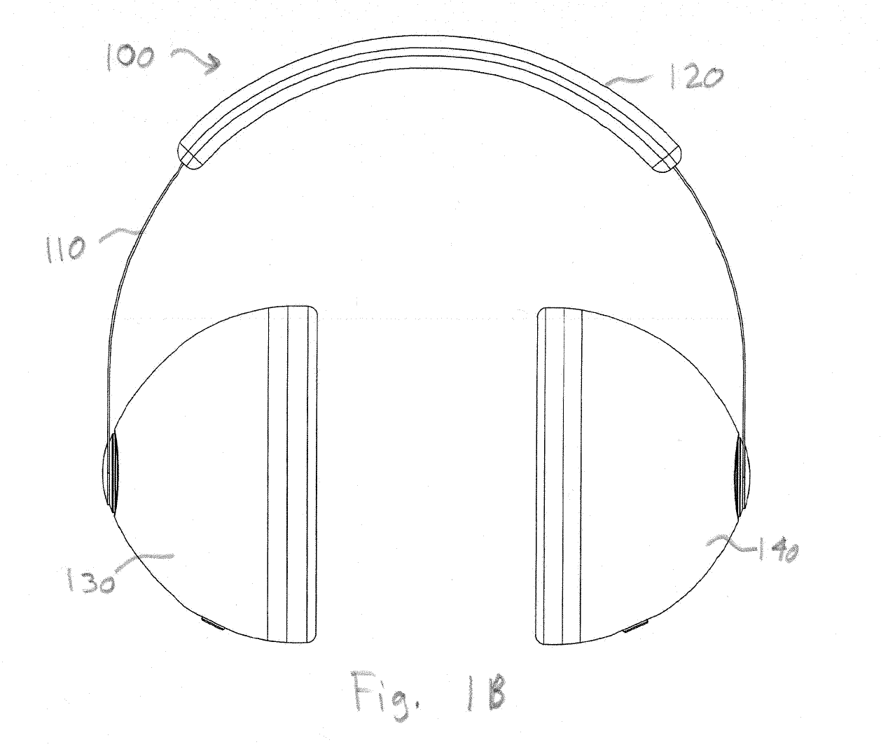

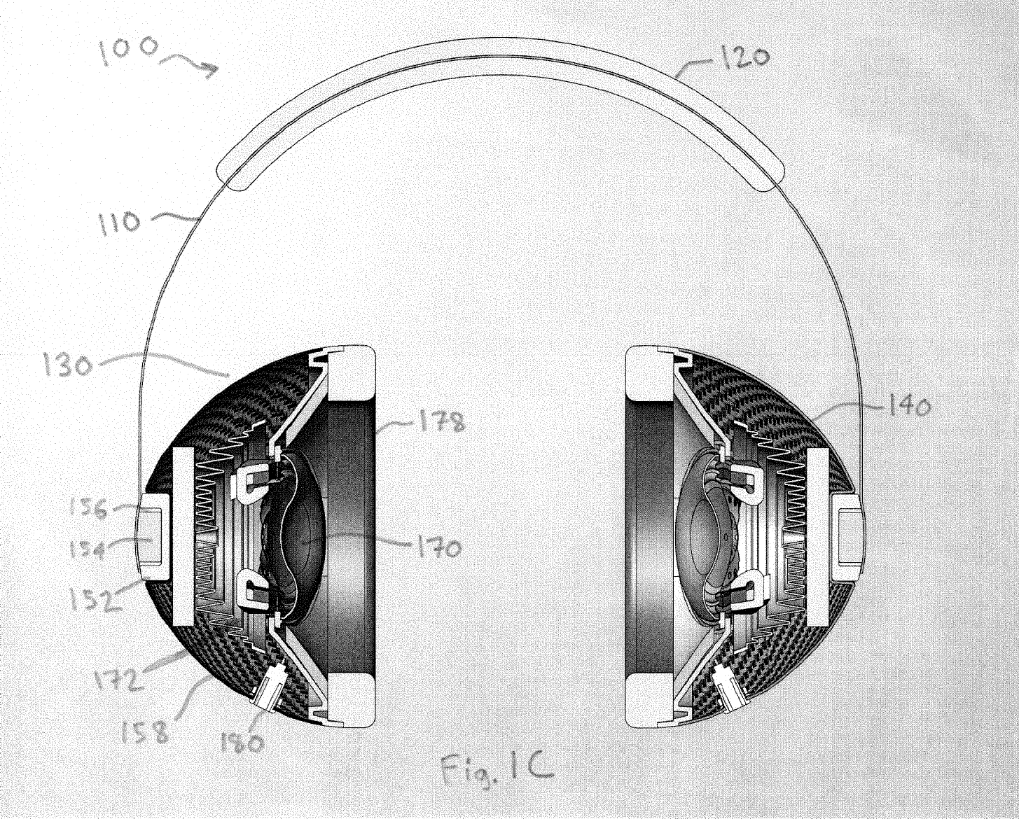

Embodiments according to the present disclosure can comprise headphone assemblies with novel and improved component efficiency. FIG. 1A displays one embodiment of headphone assembly 100, which comprises many of the novel and improved features described herein. Headphone assembly 100 can have features that optimize the efficiency and performance of components, such as by maximizing and/or improving the versatility and movement of components. Moreover, headphone assembly 100 can include features which allow individual components to be freely separable and/or removable from one another. Additionally, headphone assembly 100 can improve component adjustability, which can improve the device efficiency and comfort for the user.

Headphones assemblies according to the present disclosure can comprise a variety of different components. FIGS. 1A and 1B display headphone assembly 100. Headphone assembly 100 comprises several different components, such as headband 110, headband pad 120, left cup assembly 130, and right cup assembly 140.

The relative position of each component headphone assembly 100 is also important. Therefore, FIG. 1C provides a view of the component positions of headphone assembly 100. FIG. 1C also identifies some of the individual components of left cup assembly 130, such as sphere cup 152, sphere magnet 154, sphere insert 156, cup 158, speaker driver 170, diaphragm 172, ear pad 178, and connector 180.

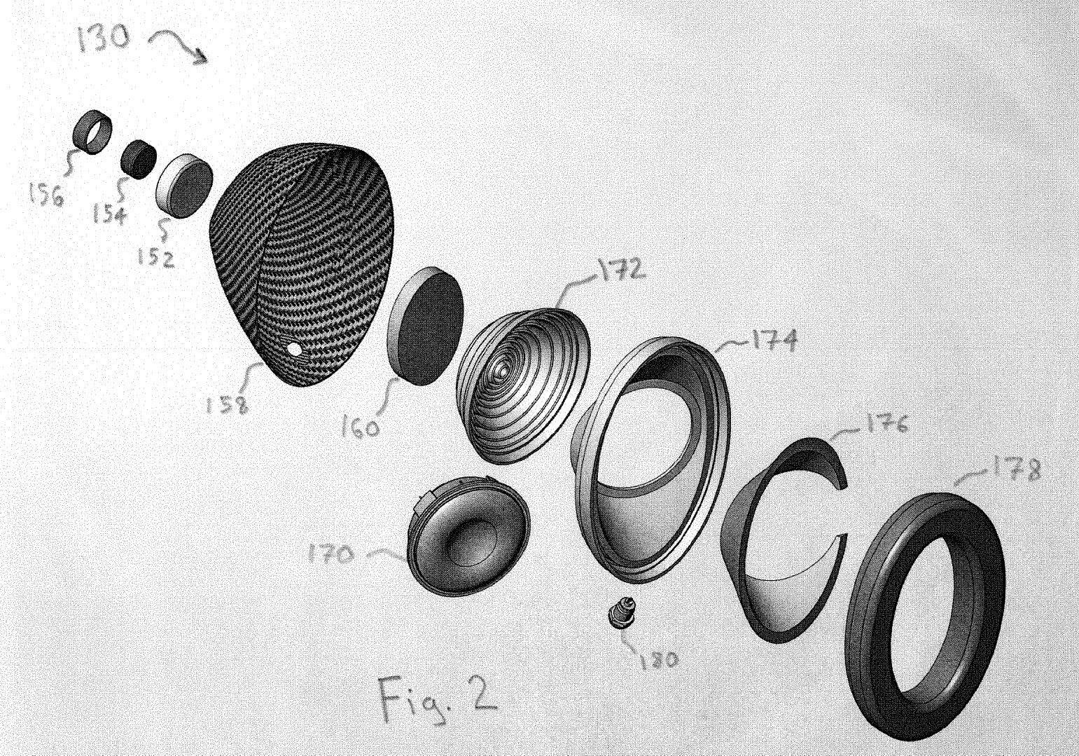

In order to properly display each of the components present in the cup assemblies, FIG. 2 provides an exploded view of left cup assembly 130. As shown in FIG. 2, left cup assembly 130 comprises sphere cup 152, sphere magnet 154, sphere insert 156, cup 158, tip cover 160, speaker driver 170, diaphragm 172, sound board 174, sound board cover 176, ear pad 178, and connector 180.

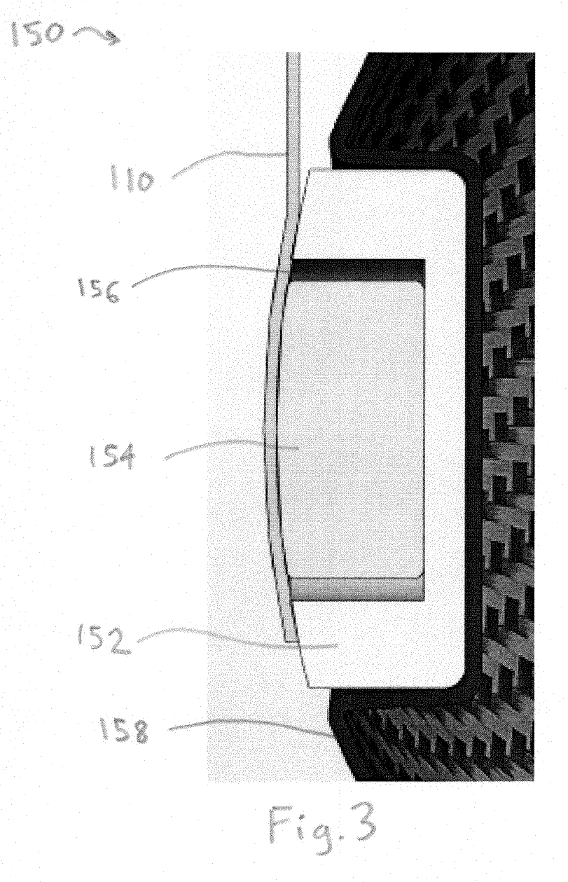

Embodiments according to the present disclosure can have novel attachment components and/or mechanisms. FIG. 3 provides a close-up view of attachment assembly 150. As shown in FIG. 3, attachment assembly 150 comprises headband 110, sphere cup 152, sphere magnet 154, sphere insert 156, and cup 158. More specifically, cup 158 can comprise an indentation, wherein sphere cup 152, sphere magnet 154, and/or sphere insert 156, fit inside this indentation. Further, headband 110 can fit on or around the sphere cup 152, sphere magnet 154, and/or sphere insert 156.

In some embodiments according to the present disclosure, cup 158 can comprise an indentation, wherein sphere cup 152 fits inside this indentation. The opening in sphere cup 152 can face outward in a direction away from cup 158. Sphere magnet 154 and sphere insert 156 can each be placed in this opening, such that sphere magnet 154 and sphere insert 156 can each fit inside of sphere cup 152. Accordingly, sphere cup 152, sphere magnet 154, and sphere insert 156 can each fit inside cup 158.

In some embodiments, sphere cup 152 can be in a fixed position inside cup 158. For example, sphere cup 152 can be held in place with an adhesive or mechanical fastener. In this manner, the sphere cup 152 will not move from its position in cup 158. Likewise, sphere magnet 154 and sphere insert 156 can be in a fixed position inside sphere cup 152. Sphere magnet 154 and sphere insert 156 can also be held in place with an adhesive or mechanical fastener. In some embodiments, the adhesive can be glue; however, it is understood that any number of adhesives are acceptable.

Headband 110 can be attached to, and/or fit on, over, or around, sphere cup 152, sphere magnet 154, and sphere insert 156. In some embodiments according to the present disclosure, headband 110 can be attached to sphere cup 152, sphere magnet 154, and/or sphere insert 156 with a magnetic force. For instance, headband 110 can be attached to the rest of attachment assembly 150 with the force of sphere magnet 154. Accordingly, headband 110 can preferably be made of a material that is capable of being held by a magnetic force, such as a metal or metallic material. In this manner, headband 110 can be detachable and/or removable from sphere cup 152, sphere magnet 154, and/or sphere insert 156.

Embodiments according to the present disclosure can maximize and/or improve the versatility and movement of the device with novel and improved component shapes and configurations. For instance, components described herein can form advantageous structures, such as a ball and socket joint. As shown in FIG. 3, headband 110, sphere cup 152, sphere magnet 154, and sphere insert 156 can combine to form a type of ball and socket joint. Specifically, headband 110 can form a concave or cup-like structure, while sphere magnet 154 and the outer portion of sphere cup 152 can form a convex or ball-like shape. Indeed, FIG. 3 displays that sphere magnet 154 and the outer portion of sphere cup 152 can fit into the concave shape of headband 110. Accordingly, this structure can form a type of ball and socket joint.

The structure of the headband 110, sphere cup 152, sphere magnet 154, and/or sphere insert 156, e.g. the ball and socket joint, can comprise a number of advantages to headphone assemblies according to the present disclosure. In some embodiments, this structure can optimize and improve component movement, efficiency, and/or performance. Indeed, the spherical design of the structure can make the headband freely movable and/or detachable. For instance, the spherical design allows the headband to attain a full freedom of movement when attached to the sphere cup 152, sphere magnet 154, and/or sphere insert 156. This design also allows for improved user comfort when wearing the headphone assembly, as the headband can move in any spherical direction. Further, this design can allow the headband 110 and sphere cup 152, sphere magnet 154, and/or sphere insert 156 to freely move in many directions, which can provide users with an increased ability to optimize component positioning and/or performance, as well as provide an improved user experience.

Additionally, the structure of the headband 110, sphere cup 152, sphere magnet 154, and/or sphere insert 156 can provide a novel manner in which to foster component adjustability. For instance, the spherical design allows users to freely move the aforementioned components in many directions. This component adjustability can allow the headphone assembly to provide adjustable shapes and/or sizes, which can help to facilitate the transition to differently shaped users. In turn, this can improve the headphone efficiency and comfort. In addition, the removable and/or adjustable aspect of the headband 110, sphere cup 152, sphere magnet 154, and/or sphere insert 156 can provide headphone users with increased mobility and/or flexibility.

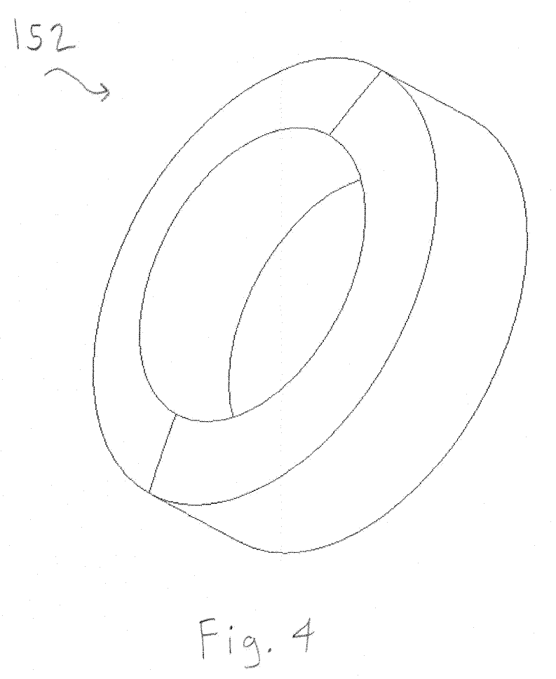

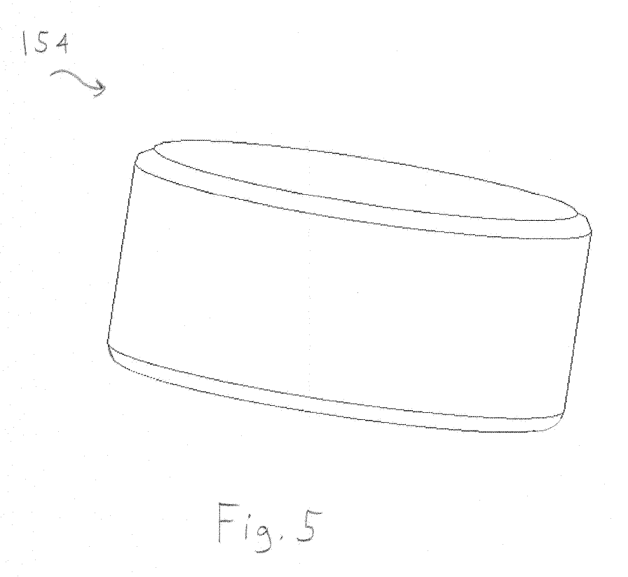

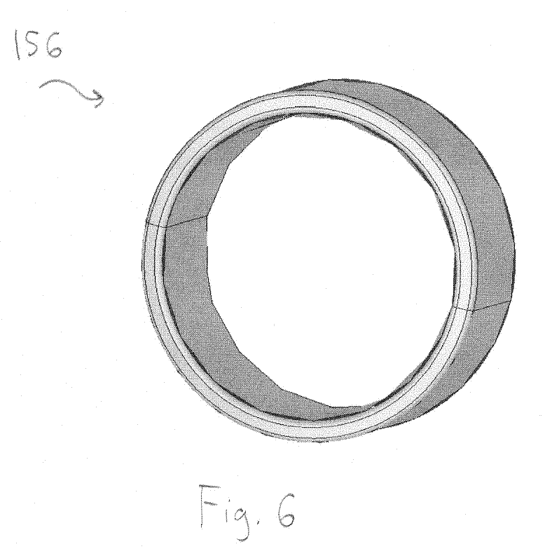

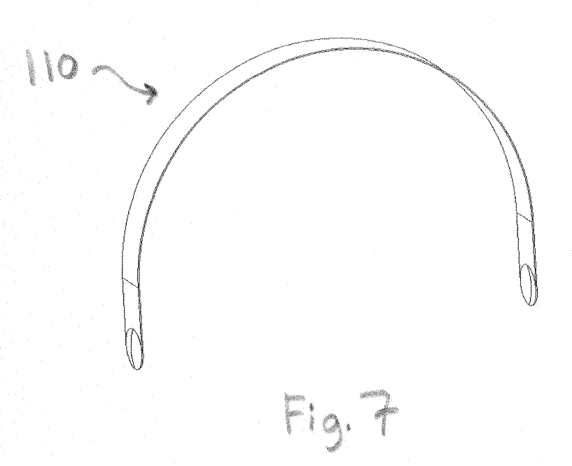

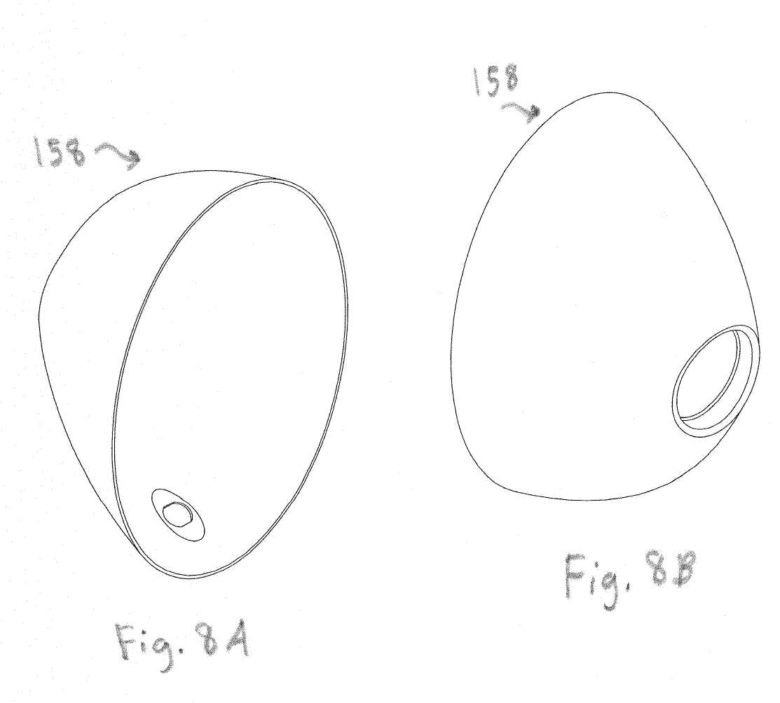

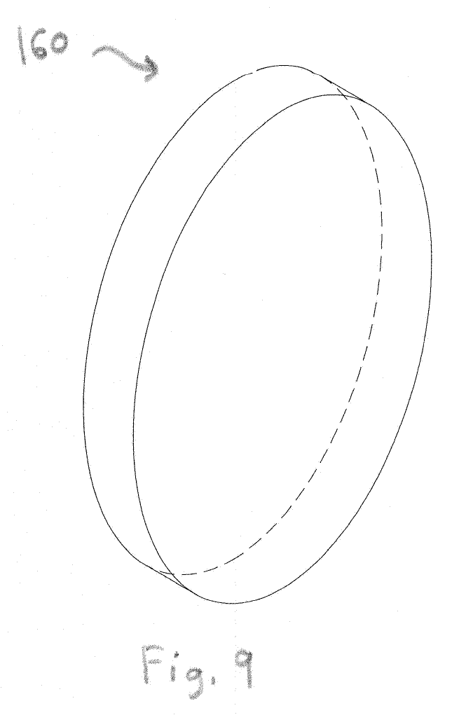

Headphone components herein can facilitate the positioning of other components that contribute to the detachability and/or adjustability of the headphone assembly. FIG. 4 displays one embodiment of a sphere cup 152 according to the present disclosure. As shown in FIG. 4, sphere cup 152 can have a cup shape, wherein sphere magnet 154 and/or sphere insert 156 fit inside sphere cup 152. As mentioned previously, sphere cup 152 can likewise fit inside of cup 158, such that sphere cup 152, sphere magnet 154, and/or sphere insert 156 can each fit inside cup 158. In some embodiments, sphere cup 152 can have a spherical shape, such that it contributes to the aforementioned spherical design and increased mobility and/or flexibility of the headphone assembly. Sphere cup 152 can also be referred to as an attachment cup, cup, and/or any other appropriate term.

Sphere cup 152 can comprise a metal or metallic material. Further, sphere cup 152 can comprise a material that can allow flux to sufficiently flow through it, such as an alloy, or more specifically a highly magnetic permeable iron alloy. For example, sphere cup 152 can comprise stainless steel. In these instances, the stainless steel can be a highly magnetic permeable ferritic or martensitic alloy. However, it is understood that sphere cup 152 can comprise any number of appropriate materials.

Headphone components herein can contribute to the detachability and/or adjustability of the headphone assembly. FIG. 5 shows one embodiment of a sphere magnet 154 according to the present disclosure. Some embodiments include sphere magnet 154 fitting inside sphere cup 152, which in turn fits inside cup 158. As described herein, sphere magnet 154 can provide the force to attach or detach headband 110 from the rest of components, namely cup 158, sphere cup 152, sphere magnet 154, and/or sphere insert 156. In some embodiments, sphere magnet 154 comprises a convex or rounded shape around the exterior, such that it has the appearance of a ball. Further, headband 110 can comprise a concave or cup-like shape, such that headband 110 can fit around and/or over sphere magnet 154, forming a ball and socket shape. In other embodiments sphere magnet 154 comprises a concave or cup-like shape around the exterior, while headband 110 can comprise a convex or ball-like shape.

Some embodiments of the present disclosure comprise a sphere magnet 154 that is relatively powerful. For instance, the magnetic force of sphere magnet 154 can be strong because there is no magnetic air gap between the sphere cup 152 and sphere magnet 154 to reduce permeability. Additionally, because the magnetic force can be strong, sphere magnet 154 can be relatively light weight to reach the target magnetic level. In some embodiments, sphere magnet 154 can be smaller in size and lower in price than comparable magnets. Accordingly, sphere magnet 154 can reduce the overall size of the headphone assembly, as well as reduce the overall production cost. Sphere magnet 154 can also be referred to as attachment magnet, magnet, and/or any other appropriate term.

Sphere magnet 154 can comprise a number of different permanent magnet materials. In some instances, sphere magnet 154 can comprise an NdFeB alloy, which is commonly called rare earth neodymium magnet. It is understood that sphere magnet 154 can comprise any appropriate type of magnetic material, such as Ferrite, Neodymium, Samarium Cobalt, AlNiCo, electromagnet, ceramic, and/or any other appropriate material.

Headphone components according to the present disclosure can also assist other headphone assembly components to be positioned properly. FIG. 6 displays one embodiment of a sphere insert 156 according to the present disclosure. Sphere insert 156 can also be referred to as attachment insert, nylon insert, sphere nylon insert, insert, and/or any other appropriate term. In some embodiments, sphere insert 156 can be on sphere magnet 154. Sphere insert 156 can also be at least partially around sphere magnet 154, such that sphere insert 156 can be between sphere magnet 154 and sphere cup 152. Sphere insert 156 can also be on headband 110. It is understood that sphere insert can be on, and contacting, a number of different components, such as sphere magnet 154, sphere cup 152, headband 110, and/or cup 158.

Sphere insert 156 can comprise a number of different materials, such as nylon, rubber, plastic, non-magnetic metal, or a non-magnetic metallic material. However, it is understood that sphere insert 156 can comprise any number of appropriate materials.

Headphone components according to the present disclosure can also be detachable and/or adjustable, which contributes to the overall user satisfaction of the headphone assembly. FIG. 7 displays one embodiment of a headband 110 according to the present disclosure. As described herein, along with cup 158, sphere cup 152, sphere magnet 154, and sphere insert 156, headband 110 can be a part of attachment assembly 150. The shape of the connection and detachment points of the attachment assembly can be designed to increase the adjustability of the headphone assembly. For instance, the structure can be spherically designed to make the headband freely movable and/or detachable. This spherical design can allows the headband 110 to attain a full freedom of movement when attached to the sphere cup 152, sphere magnet 154, sphere insert 156, and/or cup 158. This design also allows for improved user comfort when wearing the headphone assembly, as the headband 110 can move in any spherical direction. Further, this design can allow the headband 110 to freely move in many directions, which can provide users with an increased ability to optimize component adjustability, positioning, and/or performance, which in turn provides for an improved overall user experience.

In some embodiments, headband 110 is attached to the other headphone components by a purely magnetic force, such as through the force of sphere magnet 154. In other embodiments, headband 110 is attached to the other headphone components by partially magnetic force and partially other non-magnetic forces, such as an adhesive or clamp. In yet other embodiments, headband 110 can be attached by a completely non-magnetic force. It is understood that headband 110 can be attached to other headphone components by any number of appropriate forces.

As described herein, headband 110 can comprise a number of different shapes, which preferably conform to the aforementioned spherical design. For instance, headband 110 can comprise a concave or cup-like shape, such that headband 110 can fit around and/or over sphere magnet 154. This type of shape is described herein as forming a ball and socket shape. In other embodiments, headband 110 can comprise a convex or ball-like shape, while sphere magnet 154 can comprises a concave or cup-like shape around the exterior of headband 110. Headband 110 can substantially form around the shape of the sphere magnet 154 and/or sphere cup 152, such that the components are essentially form fitting over and/or around one another. This can improve the connection and fit of the components, as well as reduce the need for the sphere magnet 154 to be large or powerful, which in turn reduces the size and cost of the headphone assembly.

Headband 110 can comprise a material that is capable of being held by a magnetic force, such as a metal or metallic material. Furthermore, headband 110 can comprise a material that can allow flux to sufficiently flow through it, such as an alloy, or more specifically a highly magnetic permeable iron alloy. For example, headband 110 can comprise stainless steel. In these instances, the stainless steel can be a highly magnetic permeable ferritic or martensitic alloy. However, it is understood that headband 110 can comprise any number of appropriate materials. As shown in FIGS. 1A-1C, in addition to headband 110, headphone assembly can also comprise headband pad 120. Headband pad 120 can comprise any number of appropriate materials that provide a pad-like effect and improve user comfort.

Headband 110 can also comprise a spring-like effect, such that it can expand and/or contract to the shape of the user. As such, headband 110 can comprise any number of different spring-like materials to accommodate this feature. Additionally, headband 110 can comprise a spring component. The spring can help clamp the headphone to the user's head. In some embodiments, friction between the ear pad and the headband can hold it in position. The spring force can be balanced between light enough for ideal user comfort and strong enough to hold the headband in position. The spring can also have a long linear force range to accommodate different head widths. As such, headband 110 can have a leaf spring along its length for ideal linear spring force.

Headphone components according to the present disclosure can also facilitate the storage and/or placement of other components. FIGS. 8A and 8B display cup 158 according to one embodiment of the present disclosure. Cup 158 can also be referred to as speaker cup, headphone cup, or any other appropriate term. As most headphone assemblies comprise two speakers, cup 158 can be part of left cup assembly 130 and/or right cup assembly 140, as shown in FIGS. 1A-1C. As shown in FIG. 3, cup 158 can hold or position the other components in attachment assembly 150. Indeed, sphere cup 152 can fit inside of cup 158. As sphere magnet 154 and/or sphere insert 156 can each fit inside sphere cup 152, each of sphere cup 152, sphere magnet 154, and/or sphere insert 156 can fit on or inside cup 158. In some embodiments, headband 110 can be on or contact cup 158.

Cup 158 can comprise a variety of appropriate materials, such a carbon fiber. More specifically, some cup embodiments of the present disclosure can comprise black twill carbon fiber with a high impact strength resin. In some embodiments, cup 158 can comprise a nominal wall thickness of 0.75 mm and a mass of approximately 20 grams. Cup 158 can also comprise a polymer material such as plastic or thermoset plastic, with or without reinforcement fibers or particles. Cup 158 can also comprise an organic material such as wood or other cellulose fibers. Cup 158 can also comprise a metal or metallic material such as aluminum, magnesium, stainless steel or liquid metal. However, it is understood that cups according to the present disclosure can comprise any number of appropriate materials, weight, and/or dimensions.

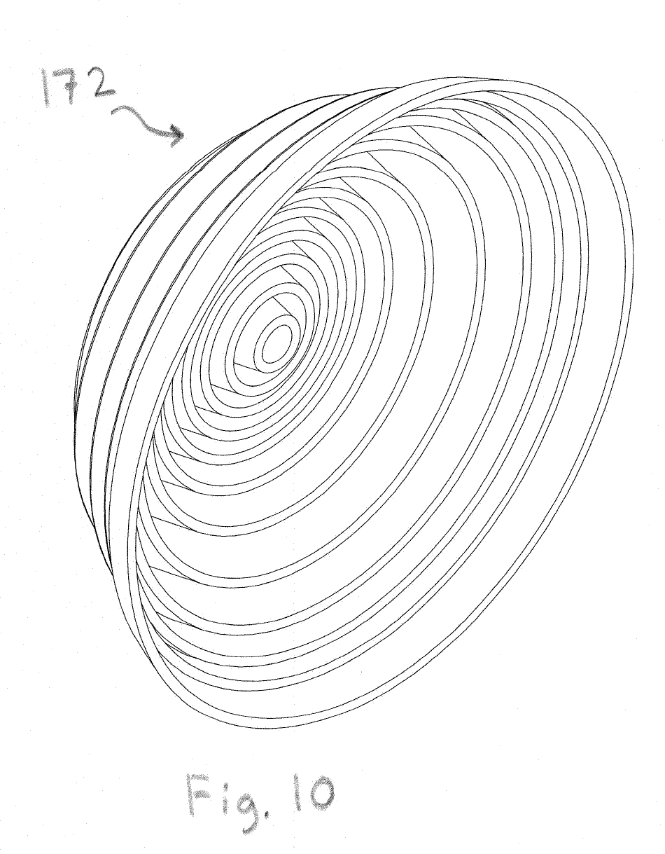

Headphone assemblies according to the present disclosure can also comprise pads and/or cover components. FIG. 9 displays one embodiment of tip cover 160 according to the present disclosure. Tip cover 160 can comprise wool felt or any appropriate pad-like material. Tip cover 160 can also comprise a natural cream color. In some embodiments, tip cover 160 can weigh 1.54 grams. It is understood that tip covers according to the present disclosure can comprise any appropriate material, weight, or dimension.

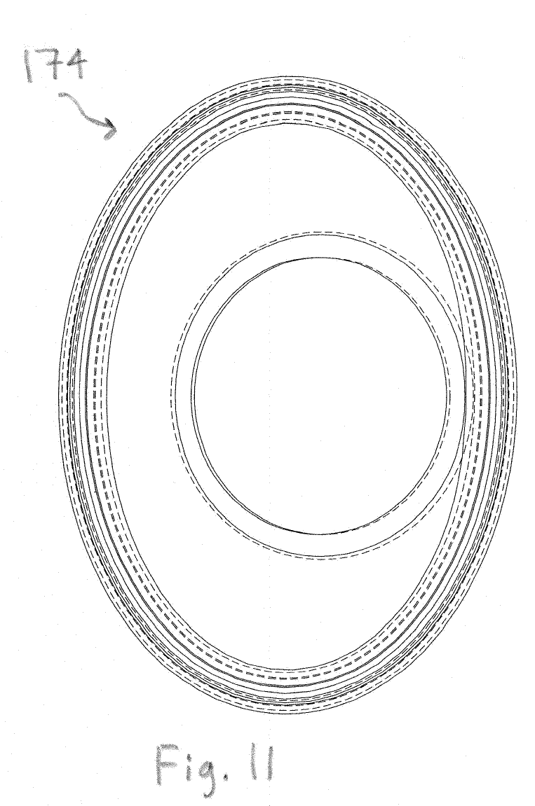

Embodiments according to the present disclosure can also comprise components that have sound dampening capabilities. FIG. 10 displays one embodiment of diaphragm 172 according to the present disclosure. Diaphragm 172 can comprise an accordion type shape to diffuse sound reflections, as well as provide a soft spring compliance. Furthermore, the shape of the diaphragm can be round so that it acts as a floating dipole membrane inside of an elliptical cup, so as not to cause a Helmholtz resonance. Diaphragm 172 can comprise a variety of appropriate materials, such as rubber, or more specifically high vibration loss rubber. As diaphragm 172 can have dampening capabilities, it can also be referred to as a dampening diaphragm. In some embodiments, the diaphragm can be 0.5 mm thick and have a diameter of around 66 mm. Moreover, the diaphragm can have a mass of approximately 152 grams. It is understood that diaphragms according to the present disclosure can comprise any appropriate material, weight, or dimension.

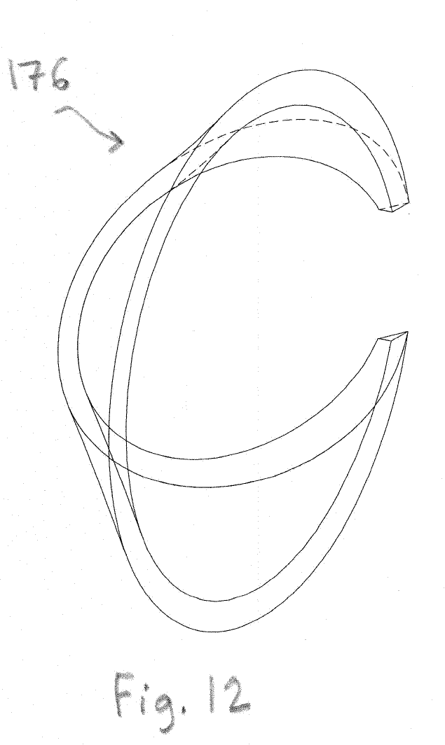

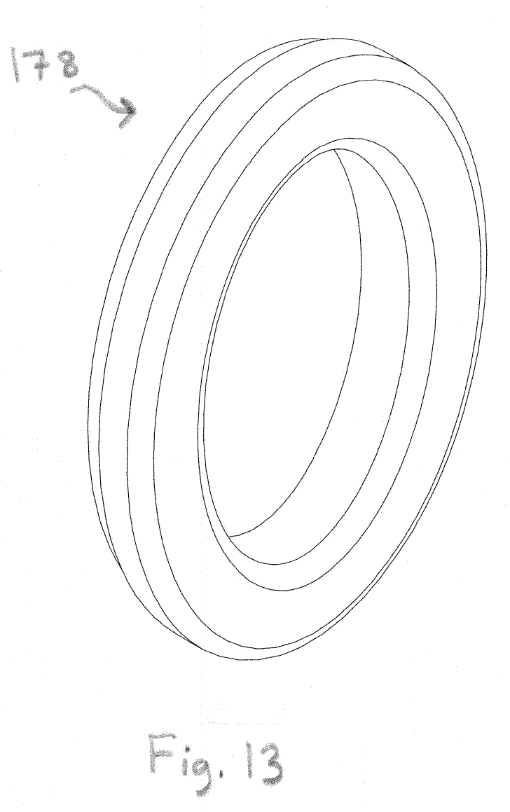

The present disclosure also provides novel sound boards and similar components. FIG. 11 displays sound board 174. In some embodiments, sound board can comprise a natural color finish and a clear satin powder coat. Sound board 174 can also comprise magnesium and/or aluminum, wherein specific embodiments can have 23.7 grams and 37.4 grams of each material, respectively. Sound board 174 can also comprise a composite material such as carbon fiber, plastic, wood, metal or liquid metal. In some embodiments, sound board 174 can comprise a nominal wall thickness of 1.5 mm. FIG. 12 displays sound board cover 176, which can comprise wool felt or cotton felt and a natural cream color. In some embodiments, sound board cover 176 can weigh 1.46 grams. It is understood that sound boards and sound board covers according to the present disclosure can comprise any appropriate material, weight, or dimension.

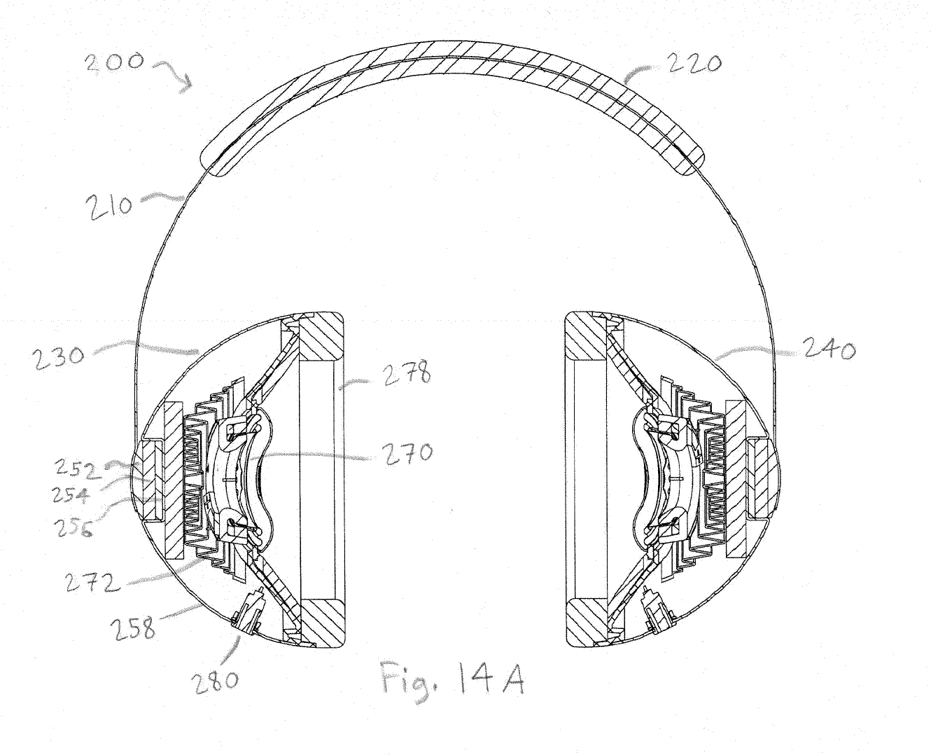

Headphone assemblies according to the present disclosure can also comprise additional pads and/or cover components. FIG. 13 displays one embodiment of ear pad 178 according to the present disclosure. Ear pad 178 can comprise memory foam, such as a high resilient memory foam and/or a soft, low density foam with characteristics of around three pounds per cubic feet. Some embodiments of ear pads can also comprise black sheep glove leather covers. In some embodiments, ear pads according to the present disclosure can weigh around 1 gram. It is understood that ear pads according to the present disclosure can comprise any appropriate material or dimension.

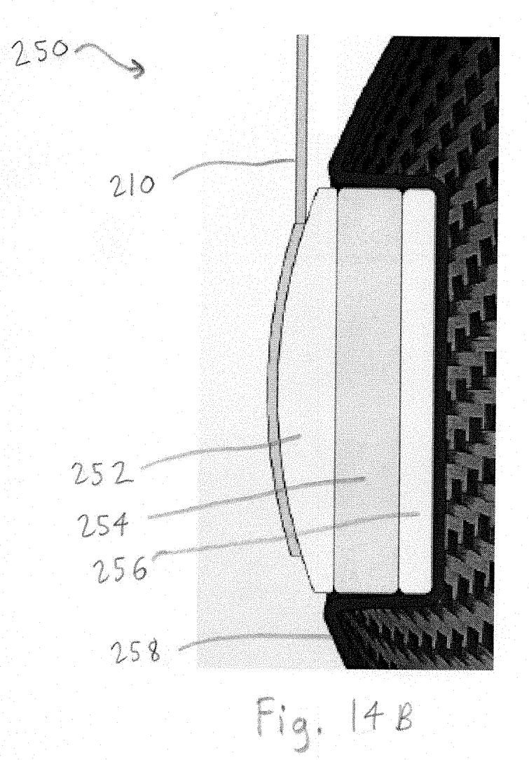

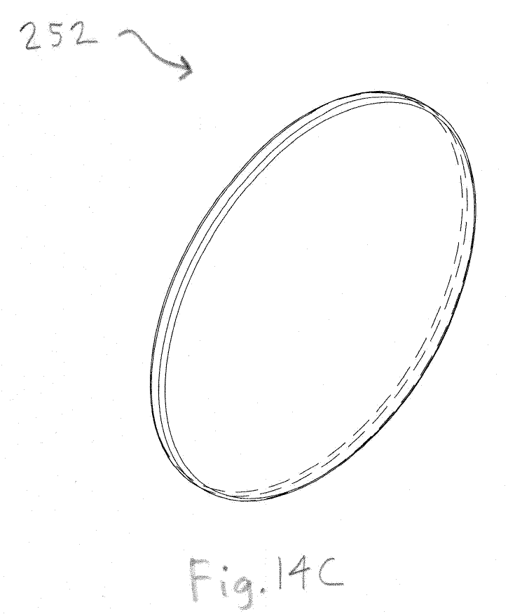

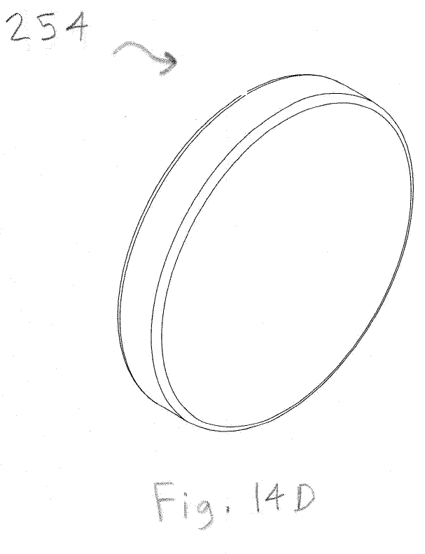

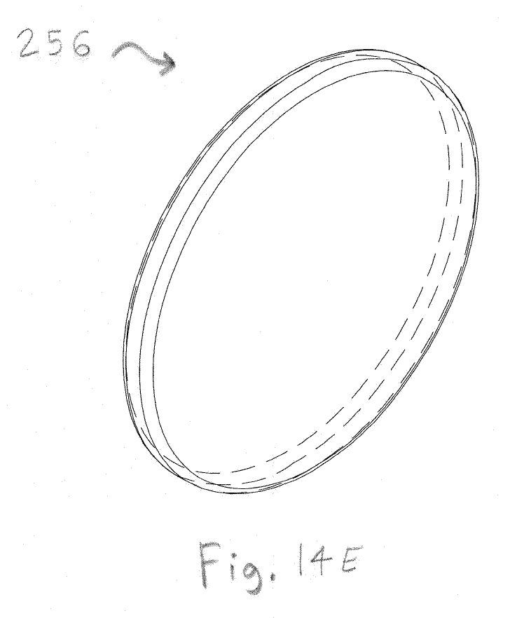

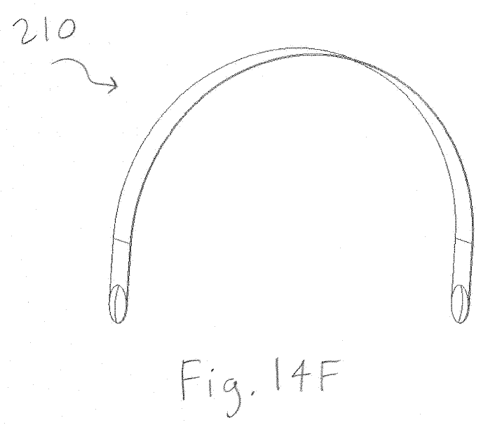

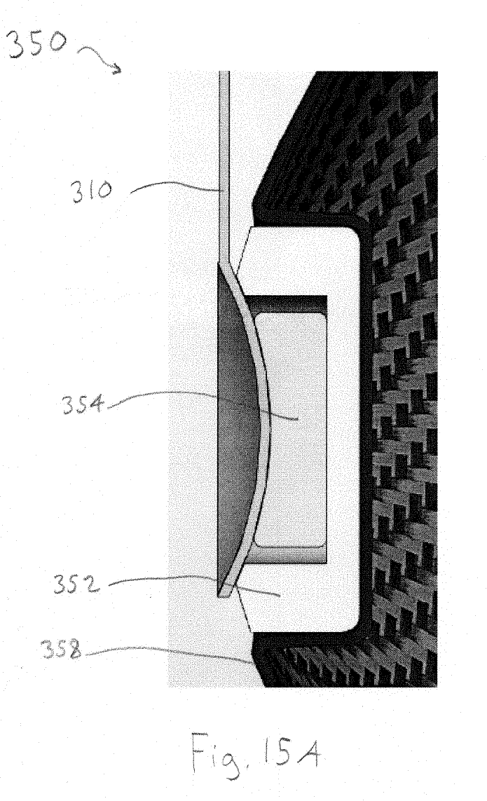

Embodiments according to the present disclosure can also comprise different types of attachment components and/or mechanisms. For instance, embodiments according to the present disclosure can utilize an air gap. FIG. 14A displays headphone assembly 200. The relative position of each component headphone assembly 200 is important, so FIG. 14A provides a view of the component positions of headphone assembly 200. Headphone assembly 200 comprises several different components, such as headband 210, headband pad 220, left cup assembly 230, and right cup assembly 240. FIG. 14A also identifies some of the individual components of left cup assembly 230, including tip bearing 252, tip magnet 254, tip pole 256, cup 258, speaker driver 270, diaphragm 272, ear pad 278, and connector 280.

FIG. 14B provides a close-up view of attachment assembly 250. As shown in FIG. 14B, attachment assembly 250 comprises headband 210, tip bearing 252, tip magnet 254, tip pole 256, and cup 258. More specifically, cup 258 can comprise an indentation, wherein tip bearing 252, tip magnet 254, and/or tip pole 256 can fit inside this indentation. Furthermore, headband 210 can fit on or around the tip bearing 252, tip magnet 254, and/or tip pole 256.

As mentioned previously, attachment assembly 250 can utilize an air gap. For example, one side or pole of tip magnet 254 can face the headband 210. The opposite side or pole of tip magnet 254 can pass through low permeability air gap, which can complete the magnetic circuit of flux flowing through the headband 210. This aspect of attachment assembly 250 can help the components attach to one another. One advantage of this type of attachment assembly is that the components can be a relatively simple shape, which can lower production costs.

As mentioned above, the tip of the left cup assembly 230 comprises several components, such as a tip bearing, tip magnet, and/or tip pole. FIG. 14C displays tip bearing 252. Tip bearing 252 can comprise a type of steel material, such as 409 stainless steel, and have a satin finish. In some embodiments, tip bearing 252 can weigh 8.7 grams. FIG. 14D displays tip magnet 254, which can comprise a nickel material with a black coat, as well as be magnetized with license. In some embodiments, tip magnet 254 can weigh 14.3 grams. FIG. 14E displays tip pole 256, which can also comprise a steel material, such as 409 stainless steel, and have a satin finish. In some embodiments, tip pole 256 can weigh 7.6 grams. It is understood that tip magnets, bearings, and/or poles according to the present disclosure can comprise any appropriate material, weight, or dimension. FIG. 14F provides a more complete view of headband 210.

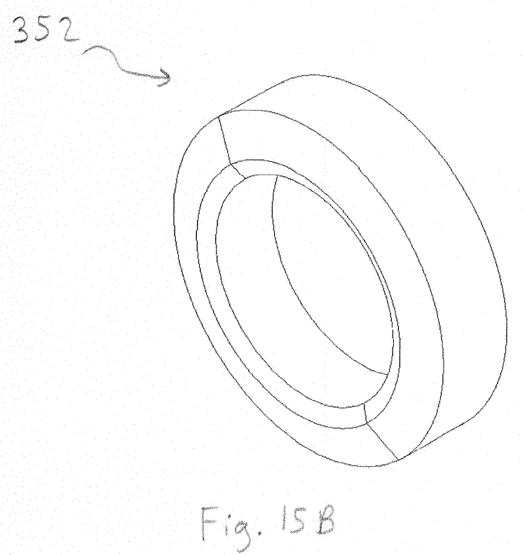

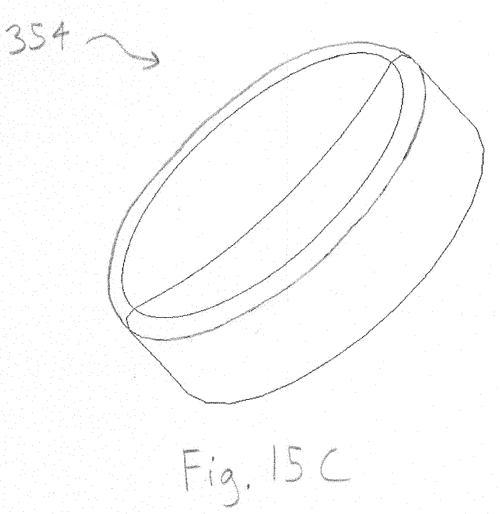

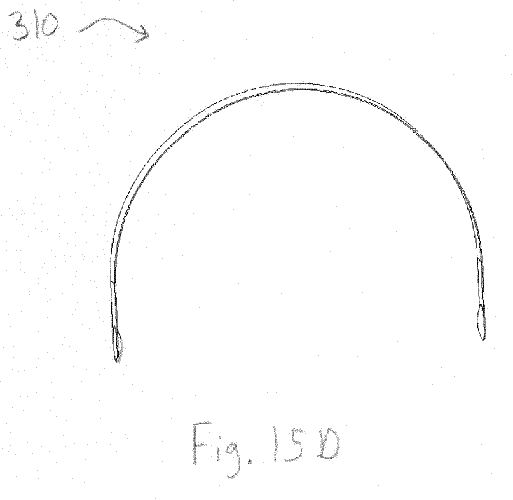

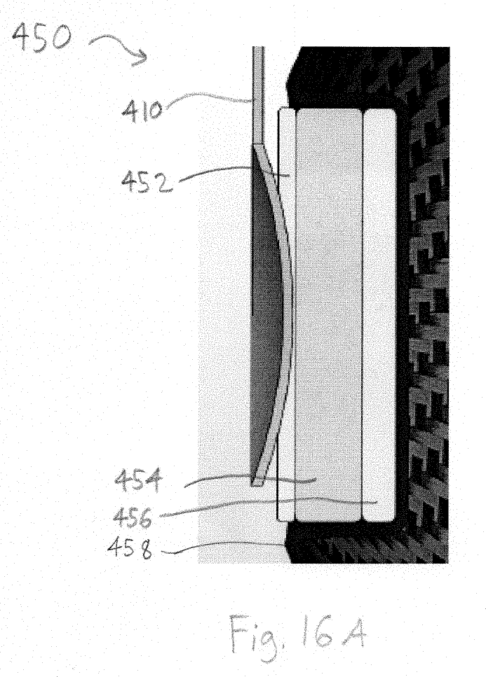

Embodiments according to the present disclosure can also comprise inverted attachment components and/or mechanisms. For example, FIG. 15A provides a close-up view of attachment assembly 350. As shown in FIG. 15A, attachment assembly 350 comprises headband 310, sphere cup 352, sphere magnet 354, and cup 358. FIGS. 15B-15D display sphere cup 352, sphere magnet 354, and headband 310, respectively.

In the embodiment shown in FIG. 15A, the headband 310 is a convex or ball-like shape, while the sphere magnet 354 is a concave or cup-like shape. Accordingly, the embodiment shown in FIG. 15A can be referred to as inverted, especially when compared to the embodiment in FIG. 3. As indicated previously, cup 358 can comprise an indentation, wherein sphere cup 352 and/or sphere magnet 354 can fit inside this indentation. Moreover, headband 310 can fit on or inside the sphere cup 352 and/or sphere magnet 354. In some embodiments, the opening in sphere cup 352 can face outward in a direction away from cup 358. Sphere magnet 354 can be placed in this opening, such that sphere magnet 354 can fit inside of sphere cup 352. Accordingly, each of sphere cup 352 and sphere magnet 354 can fit inside cup 358.

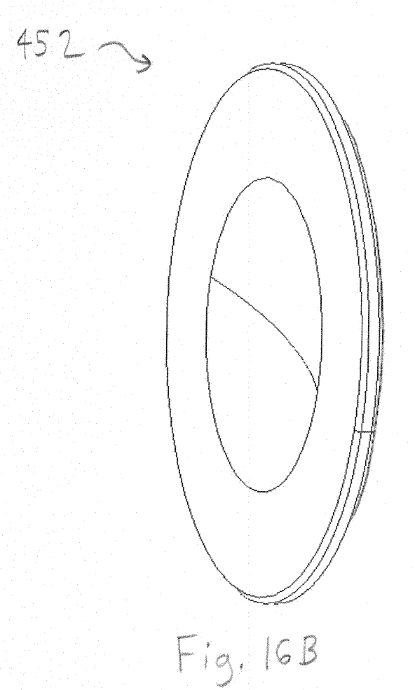

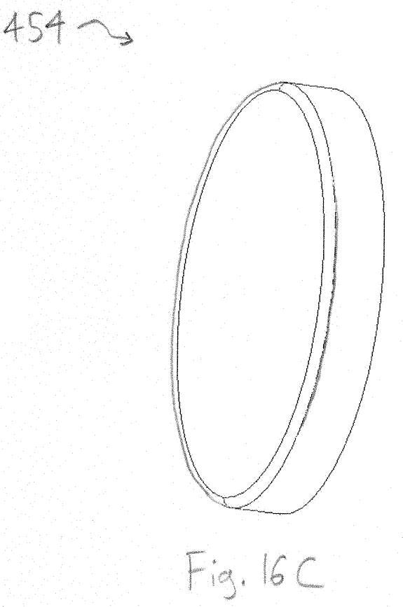

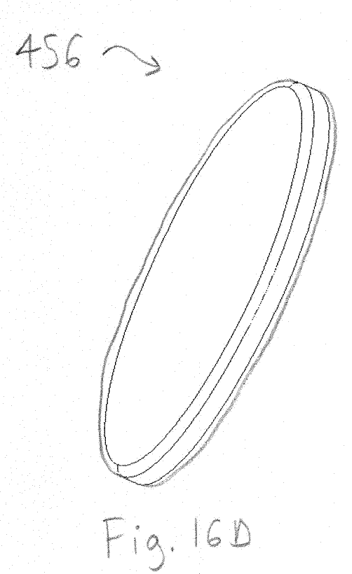

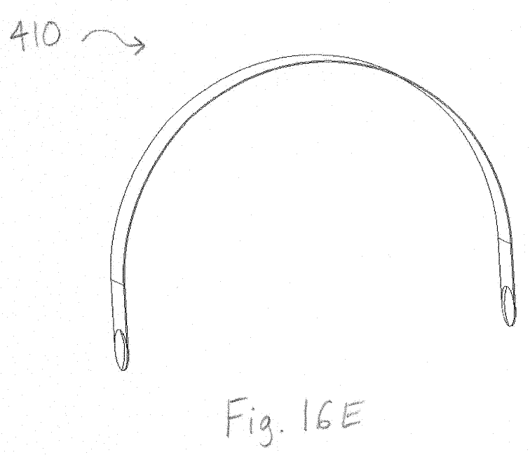

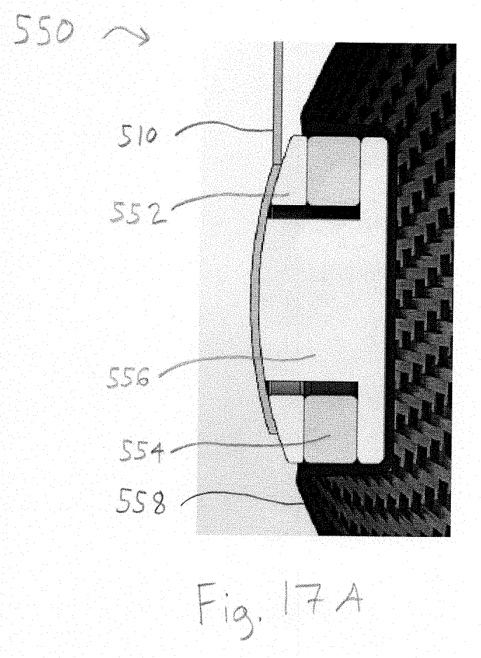

Embodiments according to the present disclosure can also comprise different inverted attachment components and/or mechanisms. FIG. 16A provides a close-up view of attachment assembly 450. As shown in FIG. 16A, attachment assembly 450 comprises headband 410, tip bearing 452, tip magnet 454, tip pole 456, and cup 458. FIGS. 16B-16E display tip bearing 452, tip magnet 454, tip pole 456, and headband 410, respectively.

In the embodiment shown in FIG. 16A, the headband 410 is a convex or ball-like shape, while the tip bearing 452 is a concave or cup-like shape. As such, the embodiment shown in FIG. 16A can be referred to as inverted, especially when compared to the embodiment in FIG. 14A. Additionally, cup 458 can comprise an indentation, wherein tip bearing 452, tip magnet 454, and/or tip pole 456 can fit inside this indentation. Moreover, headband 410 can fit on or inside the tip bearing 452, tip magnet 454, and/or tip pole 456.

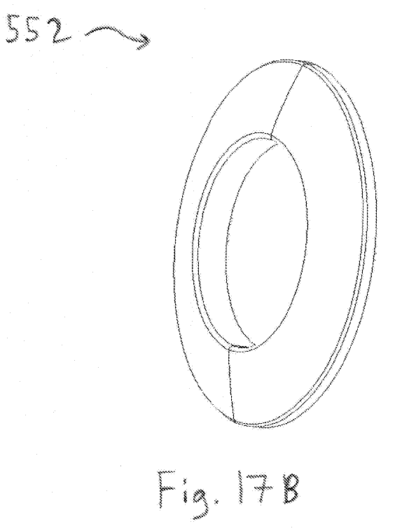

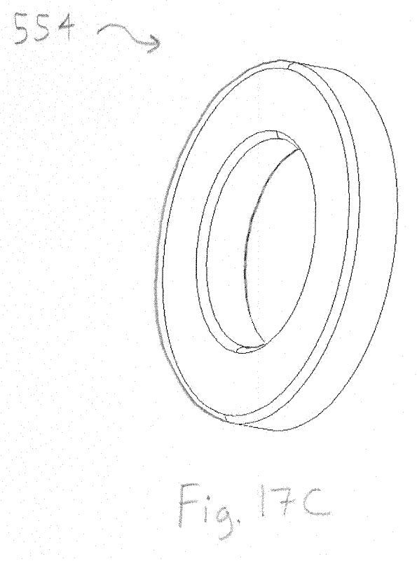

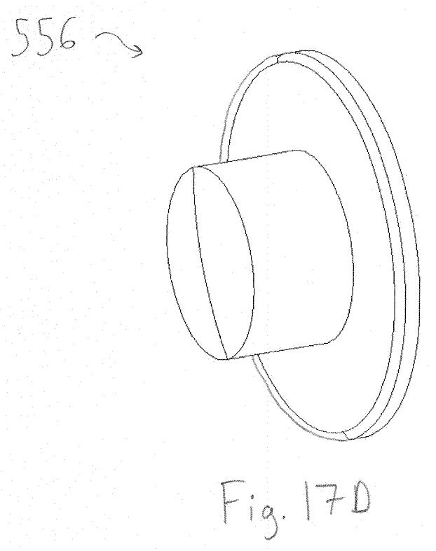

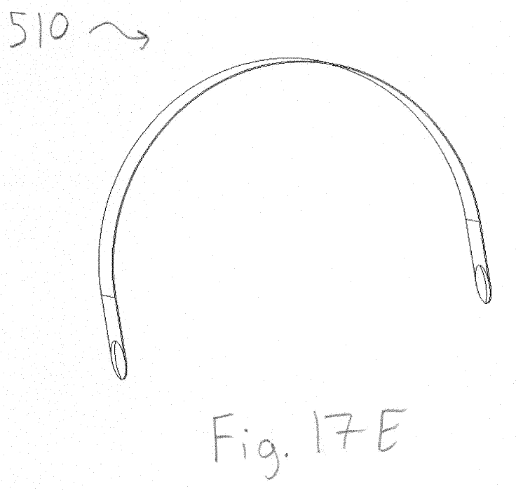

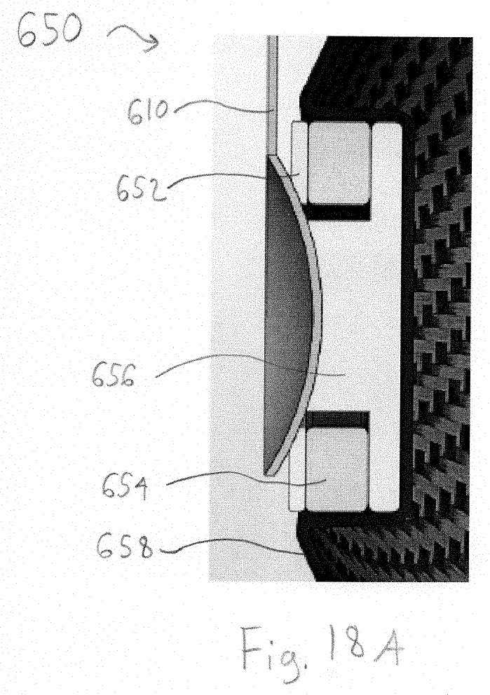

Embodiments according to the present disclosure can also comprise attachment components and/or mechanisms that utilize a ring-like shape. FIG. 17A provides a close-up view of attachment assembly 550. As shown in FIG. 17A, attachment assembly 550 comprises headband 510, tip bearing 552, tip magnet 554, tip pole 556, and cup 558. FIGS. 17B-17E display tip bearing 552, tip magnet 554, tip pole 556, and headband 510, respectively.

As shown in FIGS. 17A-17C, tip bearing 552 and tip magnet 554 can form a ring-like shape. Further, tip pole 556 can form a type of pole shape on one side. Accordingly, tip bearing 552 and tip magnet 554 can fit over and around tip pole 556, such that the structure can resemble rings over a pole. In addition, cup 558 can comprise an indentation, wherein tip bearing 552, tip magnet 554, and/or tip pole 556 can fit inside this indentation. Further, headband 510 can fit on or around the tip bearing 552, tip magnet 554, and/or tip pole 556. More specifically, in the embodiment shown in FIG. 17A, the headband 510 is a concave or cup-like shape, while the tip pole 556 is a convex or ball-like shape. In this manner, attachment assembly 550 can resemble the ball and socket-like structure described previously.

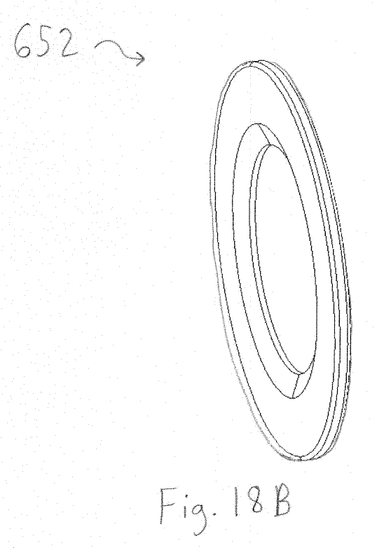

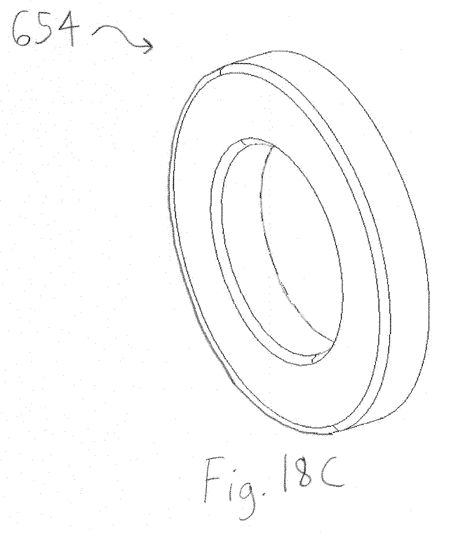

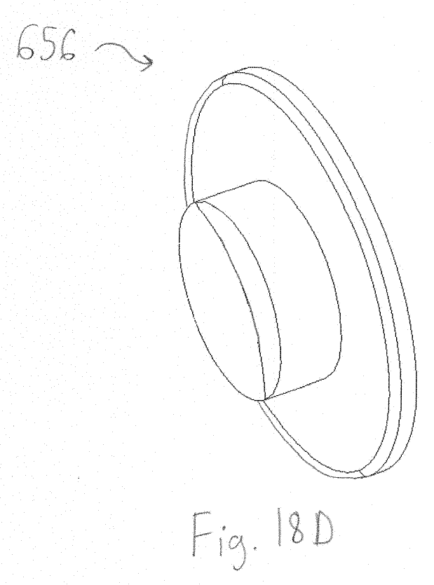

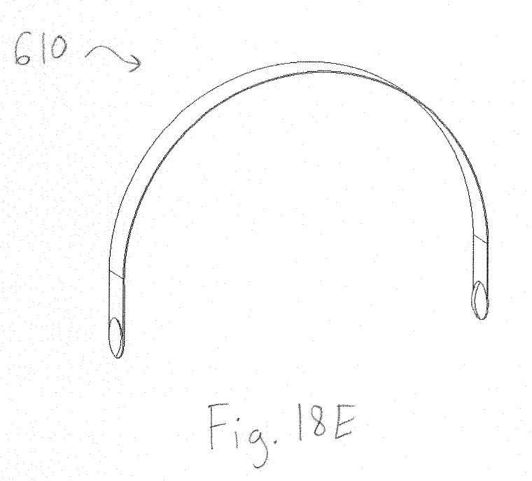

Embodiments according to the present disclosure can also comprise attachment components and/or mechanisms that utilize inverted ring-like shapes. FIG. 18A provides a close-up view of attachment assembly 650. As shown in FIG. 18A, attachment assembly 650 comprises headband 610, tip bearing 652, tip magnet 654, tip pole 656, and cup 658. FIGS. 18B-18E display tip bearing 652, tip magnet 654, tip pole 656, and headband 610, respectively. In the embodiment shown in FIG. 18A, the headband 610 is a convex or ball-like shape, while the tip pole 656 is a concave or cup-like shape. As such, the embodiment shown in FIG. 18A can be referred to as inverted, especially when compared to the embodiment in FIG. 17A.

It is understood that embodiments presented herein are meant to be exemplary. Embodiments of the present disclosure can comprise any combination of compatible features shown in the various figures, and these embodiments should not be limited to those expressly illustrated and discussed.

Although the present disclosure has been described in detail with reference to certain configurations thereof, other versions are possible. Therefore, the spirit and scope of the disclosure should not be limited to the versions described above.

The foregoing is intended to cover all modifications and alternative constructions falling within the spirit and scope of the disclosure as expressed in the appended claims, wherein no portion of the disclosure is intended, expressly or implicitly, to be dedicated to the public domain if not set forth in the claims.

We claim:

1. A headphone assembly, comprising:
at least one speaker cup;
an attachment cup on at least a portion of said speaker cup;
an attachment magnet on at least a portion of said attachment cup; and
a headband on said attachment magnet.

2. The headphone assembly of claim 1, wherein said headband is detachably attached to said attachment magnet with a magnetic force.

3. The headphone assembly of claim 1, wherein said headband substantially forms around the shape of said attachment magnet.

4. The headphone assembly of claim 1, further comprising an attachment insert on at least a portion of said attachment magnet.

5. The headphone assembly of claim 4, wherein said attachment insert is at least partially around said attachment magnet.

6. The headphone assembly of claim 1, wherein said attachment cup is at least partially inside a portion of said speaker cup.

7. The headphone assembly of claim 1, wherein said attachment magnet is at least partially inside a portion of said attachment cup.

8. The headphone assembly of claim 1, wherein said headband is on said attachment cup.

9. A headphone assembly, comprising:
at least one attachment assembly, comprising:
a speaker cup;
a sphere cup on said speaker cup;
an attachment device on said sphere cup; and
a headband on said attachment device;
wherein said headband substantially forms around the shape of said attachment device.

10. The headphone assembly of claim 9, wherein the exterior of said attachment device comprises a convex shape.

11. The headphone assembly of claim 9, wherein the exterior of said attachment device comprises a concave shape.

12. The headphone assembly of claim 9, wherein said attachment device comprises a magnetic force.

13. The headphone assembly of claim 9, wherein said headband is detachably on said attachment device.

14. The headphone assembly of claim 9, further comprising an attachment insert on at least a portion of said attachment device.

15. The headphone assembly of claim 9, wherein said sphere cup is at least partially inside a portion of said speaker cup.

16. The headphone assembly of claim 9, wherein said attachment device is at least partially inside a portion of said sphere cup.

17. A headphone assembly, comprising:
a left cup assembly and a right cup assembly, each cup assembly comprising:
a speaker cup;
an attachment cup on at least a portion of said speaker cup; and
an attachment device on at least a portion of said attachment cup;
a headband comprising a left attachment portion and a right attachment portion;
wherein said left and right attachment portions are detachably on said left and right cup assemblies, respectively.

18. The headphone assembly of claim 17, wherein said attachment device comprises a magnetic force.

19. The headphone assembly of claim 17, further comprising an attachment insert on at least a portion of said attachment device.

20. The headphone assembly of claim 17, wherein said attachment cup is at least partially inside a portion of said speaker cup.
